(19) United States
(12) Patent Application Publication
(10) Pub. No.: US 2006/0173098 A1
(43) Pub. Date: Aug. 3, 2006

(54) Process for producing powder coating composition and powder coating composition obtained by the production process

(76) Inventors: Hiroyuki Tsujimoto, Osaka (JP); Chizu Ura, Wakayama (JP); Naotoshi Kinoshita, Osaka (JP); Masaru Iwato, Osaka (JP); Kazuki Suhara, Osaka (JP)

Correspondence Address: MCDERMOTT WILL & EMERY LLP, 600 13TH STREET, N.W., WASHINGTON, DC, 20005-3096, US

(21) Appl. No.: 10/548,952

(22) PCT Filed: Mar. 22, 2004
(86) PCT No.: PCT/JP04/03889

§ 371 Date: Sep. 15, 2005

(30) Foreign Application Priority Data
Apr. 9, 2003 (JP) 2003-104997

(51) Int. Cl. C08K 9/00

(52) U.S. Cl. 523/205

(57) ABSTRACT

A production process characterized by fluidizing resin particles as a base powder and spraying the fluidized particles with a slurry containing a pigment dispersed therein to coat the surface of the resin particles with the pigment.

### TECHNICAL FIELD

The present invention relates to a process for producing a powder coating composition in which the surface of a base powder of synthetic resin is coated with a pigment prepared in liquid form. The preset invention also relates to a powder coating composition produced by such a process.

### BACKGROUND ART

Conventionally widely used powder coating compositions include those in which the surface of a base powder of synthetic resin is coated with a pigment, in which case the product is called a colorant powder coating composition, or with a metal foil powder, in which case the product is called a metallic powder coating composition. Such colorant and metallic powder coating compositions are generally produced by dry blending. Dry blending is simple blending of the powder of the resin used as a base powder with the powder of a pigment or a metal foil powder under dry conditions; specifically, in a mixer or the like, a resin powder is mixed with predetermined additives, pigments, functional resins, and the like.

An example of such a process is disclosed in Japanese Patent Application Laid-open No. H10-279695. According to the technique disclosed there, a pigment in the form of colorant particles is melted by the use of a kneader, and is then crushed in a liquid by the use of a roll mill, a bead mill, or the like to produce a liquid having the pigment dispersed therein. This liquid is then added to a base powder of a powder coating composition, and these are then mixed together by dry blending by the use of a mixer.

To cope with the recent trend of demands for such colorant and metallic powder coating compositions, it is nowadays necessary to produce them in a wide variety, that is, with different colors, patterns, glosses, and other design features, but in small quantities (in batches of several kilograms to ten and several kilograms). For this purpose, however, the conventional process described above is unsuitable because of the following disadvantages. When a colorant or metallic powder coating composition is produced by the conventional process, a base resin powder and a pigment or a metal foil powder need to be mixed together beforehand. Thus, for example, when the color of a colorant powder coating composition being produced is changed, cleaning is needed in a large part of the production line, such cleaning disadvantageously requiring large manpower and high cost. Moreover, it is generally believed that the minimum batch of a powder coating composition that justifies such requirements is about one metric ton, and this makes it impracticable to produce, by the conventional process, powder coating compositions in small units of several kilograms to ten and several kilograms. Thus, even when a wide variety of powder coating compositions are needed in small quantities, they need to be purchased in quantities larger than necessary. That is, with the conventional process, disadvantageously, it is impracticable to cope with wide-variety small-quantity production.

Moreover, in the conventional process described above, for the purpose of dispersing a pigment as evenly as possible, it is necessary to perform mixing using a mixer for a long time. When a thermally curable powder coating composition is produced, such long-time mixing raises the temperature inside the mixer, with the result that, disadvantageously, a curable agent mixed together causes part of the resin to gelate. This makes it difficult to produce such a powder coating composition. This disadvantage is particularly notable in the production of a thermally curable powder coating composition that can be baked at low temperature.

To overcome these disadvantages, and to cope with wide-variety small-quantity production, studies have been done in search of a process by which first a base powder coating composition is produced and then desired design features are added to it. An example of such process is disclosed in Japanese Patent Application Laid-open No. 2001-205186. According to the technique disclosed there, in a colorant powder coating composition produced by dry blending, a base powder of the powder coating composition and a colorant powder are prepared separately, and they are, immediately before application, mixed evenly by the use of a mixer so that the coating composition is obtained in the desired quantity and color. This makes wide-variety small-quantity production possible.

The dry blending described above, however, has the following disadvantages. The colorant powder that attaches to the surface of the base powder is highly flocculative, and moreover, in particular when the colorant powder is a fine one with a particle size of several micrometers or less, it is also poorly dispersive. Thus, it is practically impossible to disperse such a fine colorant powder so that it coats the surface of the base powder. Inconveniently, this results in poor adhesion (low adhesion strength) between the resin powder and the pigment.

Also with a metal foil powder, the dry blending described above has the following disadvantages. The adhesion between the resin powder and the metal foil powder is poor, and moreover, during application, the resin powder and the metal foil powder tend to separate at the tip of an applicator gun. This results in poor workability. Moreover, the metal foil powder that has separated at the tip of the applicator gun attaches and deposits there. From time to time, the deposit leaves the tip of the applicator and attaches to the coating surface, causing a coating defect called spit. This spoils the design of the article coated.

Furthermore, since, as described above, the adhesion between a resin powder and a pigment or a metal foil powder is poor, the two tend to separate during application. Thus, the powder coating composition retrieved for reuse after application usually contains the separated pigment or metal foil powder. This makes the reuse of the retrieved powder difficult.

To overcome these disadvantages, according to the process disclosed in Japanese Patent Application Laid-open No. 2002-338895, in an upward current of a gas containing oxygen, while a base powder is fluidized and circulated in the up and down directions, the base powder is irradiated with ultraviolet ray so that active points are formed on the surface of the base powder, and, with the base powder in this state, a pigment in the form of powder or fine flakes is brought into contact.

According to another conventionally disclosed process, in a fluidized bed, a resin powder as a base powder and a pigment or a metal foil powder are dispersed and mixed together, and moreover, for the purpose of binding their particles together, during the mixing, a binder in the form of spray is supplied into the fluidized bed (for example, see Japanese Patent Application Laid-open No. 2004-2633).

As compared with dry blending, the above-described process involving the irradiation of ultraviolet rays does help improve the adhesion between the resin powder and the pigment, but has the following disadvantages. The pigment in a gas current is not very dispersive, and therefore, with its own action in a gas current alone, it is difficult to coat the surface of the resin powder satisfactorily with the dispersed pigment even when it is supplied in the form of highly flocculative powder or fine flakes. Moreover, the pigment, when it coats the surface of the resin powder, is in a flocculated state, and this makes it difficult to obtain an even color in the appearance of a coating finished with a colorant powder coating composition produced by the above-described process involving the irradiation of ultraviolet rays. To improve this, when the colorant powder coating composition is produced, more of the above-mentioned pigment needs to be added to it. These disadvantages are encountered also when, instead of a pigment, a fine metal foil powder is used.

As compared with dry blending, the above-described process involving the supply of a binder in the form of spray does help improve the adhesion between the resin powder and the pigment or the metal foil powder, but has the following disadvantages. In the appearance of the finished coating, it is sometimes difficult to obtain an even color and gloss. In particular with a metallic powder coating composition containing a metal foil powder, disadvantageously, a satisfactorily metallic luster is not obtained in the appearance of the finished coating.

In view of the conventionally encountered disadvantages discussed above, it is an object of the present invention to provide a process for producing a powder coating composition whereby the surface of a base powder is coated with a pigment made highly dispersive so that increased adhesion is obtained between the resin powder and the pigment, the process being capable of coping with wide-variety small-quantity production, and to provide a powder coating composition produced by such a process.

### DISCLOSURE OF THE INVENTION

To achieve the above object, according to the present invention, a process for producing a powder coating composition involves fluidizing a resin powder as a base powder and supplying a liquid in a form of slurry having a pigment dispersed therein in such a way that a spray of the pigment hits the fluidized resin powder so that the surface of the resin powder is coated with the pigment. Here, mixing a binder in the liquid in the form of slurry helps obtain increased coating stability. The pigment may be a common pigment (a pigment in the form of fine powder or fine flakes), or a metal foil powder, or a mixture of those.

It is preferable that the resin powder have a mean particle size of 5 to 50 μm.

When a common pigment is used, it is preferable that it have a mean particle size of 0.001 to 50 μm, and it is preferable that the resin powder and the pigment be mixed together in a ratio of, on a weight percentage basis, 100 of the resin powder to 0.5 to 40 of the pigment.

When a metal foil powder is used, it is preferable that it have a mean particle size of 1 to 50 μm, and it is preferable that the resin powder and the metal foil powder be mixed together in a ratio of, on a weight percentage basis, 100 of the resin powder to 0.5 to 15 of the metal foil powder.

### BRIEF DESCRIPTION OF DRAWINGS

FIG. 1 is a vertical sectional view schematically showing, as a first embodiment of the present invention, a powder treatment apparatus used in a process for producing a colorant or metallic powder coating composition; and

FIG. 2 is a vertical sectional view schematically showing, as a second embodiment of the present invention, a powder treatment apparatus used in a process for producing a colorant or metallic powder coating composition.

### BEST MODE FOR CARRYING OUT THE INVENTION

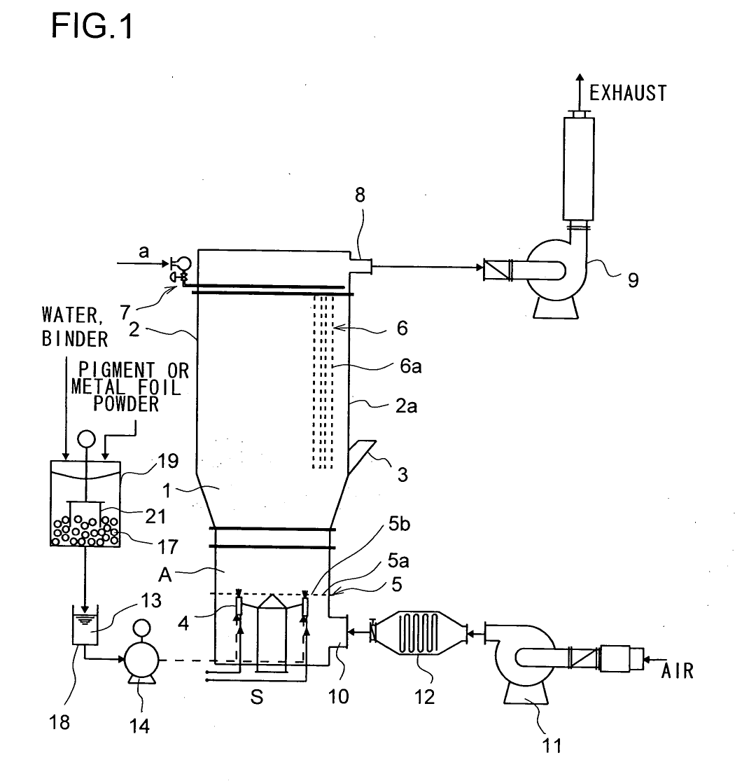

Hereinafter, embodiments of the present invention will be described with reference to the accompanying drawings. FIG. 1 is a vertical sectional view schematically showing, as a first embodiment of the present invention, a powder treatment apparatus used in a process for producing a colorant or metallic powder coating composition.

In FIG. 1, reference numeral 2 indicates a treatment apparatus main unit having a treatment chamber 1, and reference numeral 3 represents a powder material supply port provided on a wall 2a of the treatment apparatus main unit 2. In this embodiment, an upward current of air is passed through the interior of the treatment chamber 1 so that a fluidized bed is produced in a treatment area A located in a lower part of the interior of the treatment chamber 1. On the other hand, a liquid (a liquid in the form of suspended slurry) having dispersed therein a pigment (or a metal foil powder) in the form of highly flocculative fine powder or fine flakes is prepared, and a spray of this liquid in the form of suspended slurry is supplied into the fluidized bed; that is, it is supplied through the powder material supply port 3 into the treatment chamber 1. This causes the pigment (or metal foil powder) to coat the surface of the powder material (resin powder) in a fluidized state. That is, while a resin powder as a base powder is fluidized, a liquid in the form of slurry having a pigment (or metal foil powder) in the form of fine powder or fine flakes dispersed therein is supplied in such a way that a spray of the pigment hits the fluidized resin powder. This permits the surface of the resin powder to be coated with the pigment (or metal foil powder). Here, fluidization is achieved by the use of fluidizing air alone.

For the production of a colorant powder coating composition in which the surface of a resin powder as a base powder is coated with a pigment, preferred examples of the material of the resin powder include: synthetic resins such as polyester-urethane curable resin, epoxy-polyester curable resin, epoxy resin, acrylic resin, acrylic-polyester resin, fluororesin, acrylic-urethane curable resin, acrylic-melamine curable resin, and polyester-melamine curable resin. One of these materials is used singly or two or more of them are used in combination to prepare the base powder, with appropriate quantities of modifier and plasticizer added thereto as necessary. Examples of modifiers include: novolac resin, phenoxy resin, butyral resin, ketone resin, polyester resin, and rosin. Example of plasticizers include: epoxidized oil and dioctyl phthalate.

Preferred examples of the material of the pigment includes: colorant pigments such as titanium dioxide, iron black, iron red, iron oxides, zinc dust, antimony white, carbon black, pigment yellow, mapico yellow, red lead, cadmium yellow, zinc sulfide, lithopone barium sulfate, lead sulfate, barium carbonate, calcium carbonate, white lead, alumina white, phthalocyanine pigments, quinacridone pigments, azo pigments, isoindolinone pigments, flavanthrone pigments, anthraquinone pigments, anthrapyridine pigments, pyranthrone pigments, dioxazine pigments, perylene pigments, perinone pigments, and various baked pigments; and extender pigments such as silica, talc, barium sulfate, calcium carbonate, and glass flakes.

The process of this embodiment for producing a colorant powder coating composition is particularly suitable for the production of colorant powder coating compositions with a mean particle size of 5 to 50 μm. Accordingly, as the resin powder supplied, one with a mean particle size of 5 to 50 μm is used, and, as the pigment, one with a mean particle size of 0.001 to 50 μm is used. The resin powder and the pigment are mixed together in a ratio of, on a weight percentage basis, 100 of the resin powder to 0.5 to 40 of the pigment. The rate at which the air for fluidizing the resin powder is supplied is, on a void tower speed basis, 0.15 m/s to 1.2 m/s (converted in zero-degree, one-atmosphere terms). These conditions are common to this and the later-described second embodiments.

On the other hand, for the production of a metallic powder coating composition in which the surface of a resin powder is coated with a metal foil powder, preferred examples of the material of the resin powder include epoxy, polyester, and acrylic, and preferred examples of the material of the metal foil powder include aluminum. As the resin powder, one with a mean particle size of 5 to 50 μm is used, and, as the metal foil powder, one with a mean particle size of 1 to 50 μm is used. The resin powder and the metal foil powder are mixed together in a ratio of, on a weight percentage basis, 100 of the resin powder to 0.5 to 15 of the metal foil powder.

As shown in FIG. 1, in a lower part of the treatment apparatus main unit 2, there are provided: an air supply port 10 via which air is supplied into the treatment chamber 1; a blower 11; and a heater 12. Through an air blow outlet 5 provided in a lower part of the treatment chamber 1, air heated by the heater 12 is blown upward into the treatment chamber 1. This air fluidizes the resin powder (base powder) while keeping it in a fluidized bed and in a predetermined range of temperature. Here, the predetermined range of temperature is equal to or lower than the melting point of the resin. The resin powder is then kept in this state for a predetermined time, for example five minutes or more.

The air blow outlet 5 is a air blow member 5a that has a large number of openings 5b formed therethrough and that is fitted in a lower part of the treatment chamber 1 so as to close it there. Preferably, the pressure of the air introduced through the air blow outlet 5 is so set that individual particles are fluidized to circulate inside the treatment chamber 1.

The blow of air through the air blow outlet 5 is largely in the upward direction. Specifically, the direction may be such that air is blown vertically upward, or, by the use of protruding slit windows, obliquely upward so that a swirling current of air is formed inside the treatment chamber 1. Examples of the air blow member 5a of the type that permits air to be blown upward include a sintered metal mesh and a punched plate; examples of the type that produces a swirling current of air include a screen having protruding slit windows, which is a type of punched plate. Here, the aperture ratio is set roughly in the range from 3% to 12%; in this particular embodiment, it is set at about 5% regardless of the type of the air blow member 5a. Producing a swirling current of air as described above permits particles to be swirled upward more effectively, and thus helps make the temperature distribution inside the fluidized bed more even. Although not illustrated, separately from the air introduced through the air blow outlet 5, pressurized air may be supplied into the fluidized bed intermittently.

The state of mix of the particles inside the fluidized bed can be improved by the use of a so-called agitator that exerts a physically agitating effect, or a rotary disk that exerts a rolling effect. However, the use of a mechanism like these often causes the crushing of the metal foil powder, and thus adversely affects the color and weather-resistance of the product. In such a case, the formation of a swirling current of air or the supply of pressurized air as described above is effective. During powder treatment, the bonding of the resin powder and the metal foil powder may be promoted through the supply of a spray of a binder such as a coupler. To prevent dust explosion, ionized air may be supplied.

Next, a description will be given of the preparation of a liquid in the form of suspended slurry (hereinafter referred to simply as slurry) containing a pigment (or metal foil powder) in the form of highly flocculative fine powder or fine flakes. As shown in FIG. 1, in this embodiment, slurry is prepared by the use of a wet ball mill 19. This wet ball mill 19 is composed of an upright cylindrical vessel that has an agitating roller 21 arranged inside it and of which the interior is filled with balls 17 (for example, balls of zirconia) with inner diameters of 1 to 5 mm. When the agitating roller 21 is rotated, the balls 17 agitate the interior of the wet ball mill 19 so that the pigment or metal foil powder supplied into the wet ball mill 19 is milled into well dispersed fine powder or fine flakes.

More specifically, as shown in FIG. 1, the pigment (or metal foil powder) and water are, along with a binder used for the purpose of binding particles together, supplied into the wet ball mill 19. Since the interior of the wet ball mill 19 is filled with the balls 17, when the wet ball mill 19 is operated at a predetermined rotation rate for a predetermined time, slurry 13 is prepared. At the outlet of the wet ball mill 19 is provided a slurry tank 18 so that the prepared slurry 13 is stored in the slurry tank 18. Instead of using the wet ball mill 19, it is also possible to prepare slurry 13 by supplying the pigment, water, and a binder used for the purpose of binding particles together into a beaker and then agitating them by the use of a stirrer or a homogenizer. In particular when a metal foil powder in the form of flakes is formed into slurry, with a view to preventing the breakage of the metal foil, it is preferable to adopt an agitating method that uses a comparatively mild agitating force as achieved by the use of a stirrer or the like.

Moreover, as shown in FIG. 1, under the treatment area A, spray nozzles 4 are provided to point upward. By the action of a pump 14, the slurry 13 is supplied to the spray nozzles 4 as indicated by thick broken line arrows in the figure, and spray air is also supplied to the spray nozzles 4 as indicated by arrows S in the figure. In this way, a spray of the slurry 13 is supplied into the fluidized bed in the treatment area A. Although not illustrated, spray nozzles 4 may be provided also above the treatment area A to point downward.

Here, used as the binder is, among others:

1. one, such as a solvent, that enhances the tucking property of the powder coating composition resin itself; or

2. one that itself is an additive (coupler) for adding an adhesive property and that is dissolved, diluted, or dispersed in water or in a volatile organic solvent.

That is, the binder mixed in the slurry 13 is used for the purpose of increasing the bonding power between the resin powder and the pigment (or metal foil powder). It should be noted that the binder needs to be selected to suit the resin. In this embodiment, a binder classified to 2. above is preferably used.

Examples of couplers classified to 2. above include: those based on acrylic, acrylic acid, urethane resin, polyethylene resin, epoxy resin, polyethylene glycol, polyvinyl chloride, polyester, polypropylene, polybutadiene, polystyrene, phenol resin, metacrylic acid, terephthalic acid, acrylonitril, AS resin, ABS resin, vinyl chloride resin, fluororesin, polyvinyl alcohol, maleic acid resin, methacrylic acid resin, polyacetal, polycarbonate, alkyd resin, polyethylene terephthalate (PET) resin, polyamide resin, urea resin, melamine resin, phenol resin, silicone resin, terpene resin, vinyl, vinyl chloride, nylon, polyvinyl alcohol, cellulose, saccharides, and natural rubber. Any of these materials is used in the form dissolved or diluted in water or an organic solvent, or in the form of dispersed particles as by being crushed into particles and dispersed in water, an organic solvent, or the like so as to be prepared as slurry or suspended liquid, or by being formed into finer particles and dispersed so as to be prepared as a colloid, latex, or elastomer. When a binder in the form of dispersed particles is used, the smaller the particle size, the better. Specifically, it is preferable that the particle size be 0.1 μm to 0.3 μm. It is preferable that the binder liquid concentration (the concentration by weight of the coupler relative to the whole binder liquid) be in the range from 0.1 to 10% by weight. A diluted or dissolved additive may be supplied into the binder liquid (in this embodiment, the slurry 13).

Preferred among the various kinds of binder named above are those based on urethane resin, and it is particularly preferable to use water-based urethane resin as a coupler. One example of such a binder using water-based urethane resin is water-based urethane resin having a well-known urethane elastomer dispersed in water (manufactured under the product name “Superflex” by Dai-ichi Kogyo Seiyaku Co., Ltd.).

When a spray of the slurry 13 is supplied to hit the resin powder in the fluidized bed, for example, a spray of a water-based binder using the above-mentioned water-based urethane resin as a coupler is supplied into the fluidized bed. The water-based binder is not hazardous as is one using a organic solvent. This eliminates the need to worry about the residual organic solvent in the product. Thus, it is possible to achieve safer, more efficient production, and to prevent environmental pollution.

When a binder classified to 2. above is used, it is preferable that at least 10 ml of the binder liquid (that is, the slurry 13) in the dissolved (or diluted or dispersed) form be supplied for every 1 kg mass of the powder supplied into the fluidized bed.

The liquid (water, a volatile organic solvent, or the like; in this embodiment, water) in which the coupler is dispersed, dissolved, or diluted is selected on the basis of the flocculating power thereof. As an indicator of the flocculating power, it is possible to use the solubility factor (also called solubility coefficient; hereinafter referred to as the “SP value”), which equals the square root of the flocculating energy density of molecules. When the SP value of the liquid and the SP value of the powder coating composition resin are close together, the liquid comes close to the surface of the powder coating composition resin, and this makes it easier for the liquid to seep into the powder coating composition resin. As a result, after the liquid along with the coupler is supplied as the binder to the powder coating composition resin, disadvantageously, it takes an extremely long time to perform a drying process for removing the liquid from the powder coating composition resin. To avoid this, it is preferable that the SP value of the liquid in which the coupler is dispersed, dissolved, or diluted be ±1 or more apart from the SP value of the powder coating composition resin.

In this embodiment, first, at a predetermined temperature, the resin powder is fluidized inside the treatment chamber 1, and then, as the temperature of the powder is raised, a spray of the slurry 13 is supplied at a predetermined supply rate into the fluidized bed in the treatment area A. Thereafter, drying is performed in the treatment area A. Through this procedure, the surface of the resin powder is coated with the pigment or metal foil powder dispersed in the slurry 13, achieving the production of a colorant or metallic powder coating composition.

Here, it is preferable that the supply temperature of the fluidizing air when the slurry 13 containing the binder is supplied be 80° C. or less. Moreover, it is preferable that the interior temperature of the fluidized bed when the slurry 13 is supplied be 50° C. or less. Under these heating conditions, the resin powder is fluidized inside the treatment chamber 1 for a predetermined time; then, the slurry 13 is introduced, then the coating composition is dried, and then the product is cooled down to 40° C. or less. During this cooling, the bonding state achieved under the heated conditions is fixed, and moreover the tucking property at the surface of the resin powder, which has been increased by heating, is lowered to prevent flocculation or blocking of the coating composition. Cooling may be performed outside the apparatus currently described. In a case where the product is air-transported immediately after production, it does not necessarily have to be cooled immediately so long as it is kept fluidized.

In the drying process for removing the liquid (in this embodiment, water) that is supplied along with the coupler as the binder to the powder coating composition, the product needs to be dried so that its water content is 0.5% by weight, or further preferabley 0.3% by weight. This is because failure of appropriate removal of the liquid causes, during storage, problems such as fusion and blocking. Here, the water content denotes the content of a volatile component, be it water or a organic solvent.

The spray nozzles 4 used to add the slurry 13 may be of any type. It is preferable, however, to use a type that sprays as fine liquid particles as possible. Moreover, it is preferable to operate the spray nozzles 4 in such a way that, when water is sprayed, the size of the sprayed liquid particles is 100 μm or less on a D₉₀ (90% diameter) basis. The spray nozzles 4 may be located below, above, or at the side of the fluidized bed, or may be distributed among two or more of those locations.

As shown in FIG. 1, the powder treatment apparatus of this embodiment is provided with a filter 6 for collecting particles when air is exhausted out of the treatment chamber 1. This filter 6 is provided with a backwash mechanism 7 for shaking off the particles attached to the filter 6. In this embodiment, used as the filter 6 is a bag filter 6a. The filter 6, however, does not necessarily have to be a bag filter 6b, but may instead be, to name only a few, a common filter such as a sintered metal mesh, or a cyclone, or a rotary rotor that performs air classification. In FIG. 1, an arrow “a” indicates the filter backwash air supplied to the backwash mechanism 7. Above the treatment apparatus main unit 2, there are provided: an air exhaust port 8 via which air is exhausted out of the treatment chamber 1; and an exhauster 9.

When air is exhausted out of the treatment chamber 1, particles are collected by the bag filter 6a provided in an upper part of the treatment chamber 1. At predetermined time intervals, the backwash mechanism 7 sends pressurized air to the bag filter 6a instantaneously in the reverse direction to perform backwashing so that the particles attached to the bag filter 6a are again fluidized to circulate inside the treatment chamber 1. In this way, an instantaneous pressure is applied to the bag filter 6a from the air exhaust port 8 side thereof to the treatment chamber 1 side thereof to shake off the particles attached to the bag filter 6a.

As described above, in this embodiment, slurry 13 prepared by mixing together, by dispersion achieved by the use of a wet ball mill 19, a pigment (or metal foil powder) in the form of fine powder or fine flakes and a binder is supplied in the form of spray to the surface of a resin powder fluidized in a fluidized bed. Thus, an inherently highly flocculative pigment (or metal foil powder) can be dispersed in the slurry 13, and in addition the binder acts to increase the adhesion between the resin powder and the colorant pigment (or metal foil powder). Thus, it is possible to increase the dispersiveness of the fine colorant pigment or metal foil powder so that it surely coats the surface of the base powder. In a powder coating composition produced by the production process of this embodiment, the bonding strength between the resin powder and the colorant pigment or metal foil powder is high, and thus even the powder retrieved for reuse contains a fixed content of the colorant pigment or metal foil powder. This makes the reuse of the retrieved powder possible.

Moreover, in the production of a powder coating composition with a particular color (or metallic color), it is possible to minimize the quantity of pigment (or metal foil powder) to be added. Thus, without further adding the pigment or metal foil powder, it is possible to obtain an even color in the appearance of the finished coating.

Moreover, in this embodiment, it is possible to produce a desired powder coating composition by separately preparing a resin powder as a base and a pigment (or metal foil powder) and then, to suit the desired quantity and color, coating the surface of the resin powder with slurry 13 by supplying a spray of the slurry 13 to the resin powder fluidized in a fluidized bed. Thus, there is no need to mix beforehand the resin powder as the base with the pigment or metal foil powder. This makes it possible to add a color to a powder coating composition product at the last stage of the production process thereof. Thus, when the color of a colorant or metallic powder coating composition is changed, it is necessary only to clean the powder treatment apparatus. This helps greatly reduce the part of the production line that needs to be cleaned, and thus helps reduce the manpower and cost required for cleaning. Moreover, it is possible to produce colorant and metallic powder coating compositions suitable for wide-variety small-quantity production.

Furthermore, in this embodiment, the supply temperature of the fluidizing air when the slurry 13 having the pigment dispersed therein is supplied is, preferably, 80° C. or less, and the interior temperature of the fluidized bed when the slurry 13 is supplied is, preferably, 50° C. or less. Thus, it is possible to perform coating at the last stage of the production process of a powder coating composition product, when the operation temperature is low. This helps prevent thermal deterioration of the pigment, and also helps prevent the resin from gelating with increasing temperature.

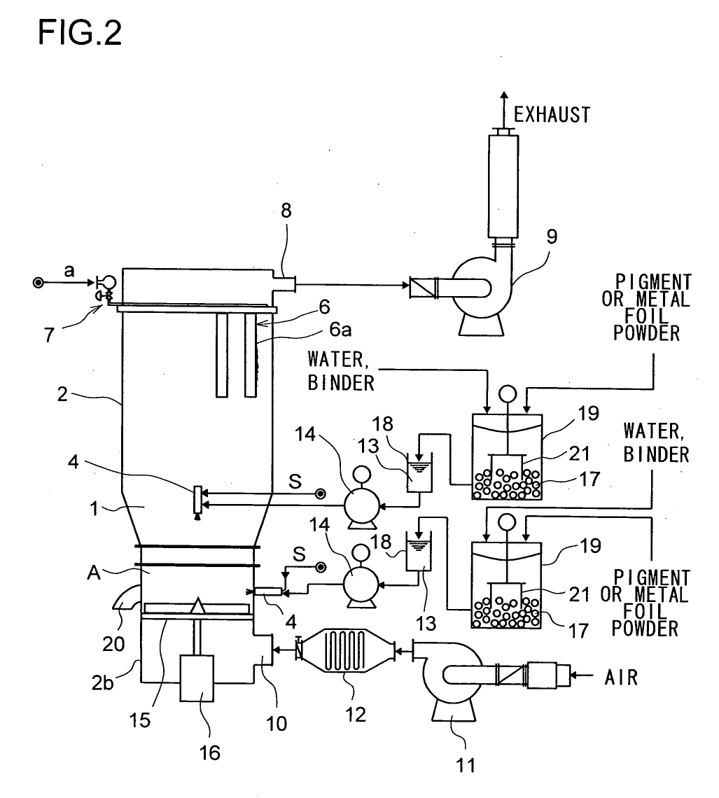

FIG. 2 is a vertical sectional view schematically showing, as a second embodiment of the present invention, a powder treatment apparatus used in a process for producing a colorant or metallic powder coating composition. In the description of this embodiment, such parts as are found also in the first embodiment described above are identified with common reference numerals, and no detailed explanation thereof will be repeated. In this embodiment, as in the first embodiment described above, air is blown upward into the treatment chamber 1 so that a fluidized bed is formed in the treatment area A provided in a lower part of the interior of the treatment chamber 1; moreover, a liquid (a liquid in the form of suspended slurry) having dispersed therein a pigment (or a metal foil powder) in the form of highly flocculative fine powder or fine flakes is prepared, and a spray of this liquid in the form of suspended slurry is supplied into the fluidized bed so that the pigment (or metal foil powder) coats the surface of the powder material supplied into the treatment chamber 1. Here, fluidization is achieved by the use of fluidizing air and an agitator on a batch basis.

In this embodiment, as shown in FIG. 2, there are provided two mechanisms for spraying the slurry 13. Specifically, at the side of a lower part of the treatment area A, a spray nozzle 4 is provided to point inward, and, above the treatment area A, another spray nozzle 4 is provided to point downward. By the action of pumps 14, the slurry 13, from two sources, is supplied to the spray nozzles 4, and simultaneously air is also supplied to the spray nozzles 4. This permits sprays of the slurry 13 to be supplied into the fluidized bed inside the treatment area A.

Furthermore, under the treatment area A, there is provided a substantially disk-shaped agitator 15. The agitator 15 is rotated by the action of an agitator motor 16. The rotation of this agitator 15 cooperates with the fluidizing air to fluidize the resin powder. In the figure, reference numeral 20 indicates a product takeout port formed in the wall 2b of the treatment apparatus main unit 2, and an arrow “a” indicates the filter backwash air supplied to the backwash mechanism 7. The conditions under which a coating composition is produced here are the same as in the first embodiment. In this embodiment, with the construction described above, it is possible to obtain the same effects as obtained in the first embodiment described previously.

Hereinafter, the present invention will be described in more detail by way of practical examples. It should be understood, however, that the present invention is not limited in any way to the examples specifically described below.

### PRACTICAL EXAMPLE 1

Used as the materials for slurry were: 50 g of a colorant pigment (“Pigment Yellow 83”, manufactured by Sanyo Color Works, Ltd.) with a mean particle size of 14 μm; and 60 g of a binder liquid (“Superflex” manufactured by Dai-ichi Kogyo Seiyaku Co., Ltd.) having a urethane elastomer dispersed in water. These were, along with 890 g of water, fed into a wet ball mill (“Aquamizer AQ-5” manufactured by Hosokawamicron Corporation) to produce slurry. Used as the balls for filling the interior of the wet ball mill were zirconia ball with an inner diameter of 3 mm. The wet ball mill was operated at a rotation rate of 250 rpm for two hours. Through this treatment, the colorant pigment came to have a mean particle size of 2 μm or less, and slurry was obtained that has the pigment well dispersed therein.

On the other hand, used as a resin powder as a base powder was 1 000 g of a white polyester powder (manufactured by Kuboko Paint Co., Ltd.). This was fed into a fluidized bed coater (“Agglomaster AGM-2SD” manufactured by Hosokawamicron Corporation) so as to be fluidized with a current of hot air at 60° C. As the temperature of the resin powder rose, a spray of the slurry prepared as described above was supplied into the bed of the fluidized powder by the use of a fluid-type bottom spray nozzle provided in the fluidized bed coater. The slurry was supplied at the rate of 15 g/min. As time passed, the resin powder became colored until, at the time that the entire quantity of the slurry prepared as described above was supplied in the form of a spray, a powder coating composition was produced that has the surface of the resin powder intensely colored in yellow. At this point, the supply of the spray was stopped. Consecutively, drying was performed with a current of hot air so that the moisture on the surface of the powder coating composition was evaporated, then cooling was performed, and then the powder coating composition was collected.

Next, with the collected powder coating composition, coating was performed (test pieces of a mild steel sheet were coated therewith, and were then baked at 180° C. for 20 minutes) by the use of an electrostatic spray gun (manufactured by Hosokawa Wagner Corporation). Then, the appearance of the finish was inspected by sight.

### COMPARATIVE EXAMPLE 1

Used were 50 g of a colorant pigment (“Pigment Yellow 83”, manufactured by Sanyo Color Works, Ltd.) and 1 000 g of a white polyester powder (manufactured by Kuboko Paint Co., Ltd.). Under irradiation of ultraviolet rays, the colorant pigment and the white polyester powder were mixed by agitation. Then, in an agitator-mixer, heated air was circulated in the mixture powder so that the mixture powder was fluidized, and thereby a powder coating composition was produced. Here, the irradiation of ultraviolet rays lasted 20 minutes. Next, with the collected powder coating composition, coating was performed in the same way as described above in connection with Practical Example 1, and the appearance of the finish was inspected by sight.

### COMPARATIVE EXAMPLE

Used were 50 g of a colorant pigment (“Pigment Yellow 83”, manufactured by Sanyo Color Works, Ltd.) and 1 000 g of a white polyester powder (manufactured by Kuboko Paint Co., Ltd.). These were mixed for 20 minutes in a plastic bag, and thereby a powder coating composition was produced. Next, with the collected powder coating composition, coating was performed in the same way as described above in connection with Practical Example 1, and the appearance of the finish was inspected by sight.

The powder coating compositions of the practical and comparative examples presented above were evaluated in terms of coating appearance, coating workability, color/gloss, alkali resistance, and retrievability. The results are shown in Table 1. Alkali resistance was tested by applying a 3 to 5% water solution of sodium hydroxide to the coating surface and then checking for color change.

TABLE 1

| Evaluation | Practical | Comparative | Comparative |
|---|---|---|---|
| Item | Example 1 | Example 1 | Example 2 |
| Coating | No flocculation | Flocculation | Strong |
| Appearance | observed in either | observed | flocculation |
| | base powder or | in pigment | observed |
| | pigment alone | | in pigment |
| Coating | Neither pigment | Both pigment | Violent pigment |
| Workability | separation nor spit | separation | separation and |
| | observed | and spit | frequent spit |
| | | observed | observed |
| Color/Gloss | Good | Insufficient | Unsatisfactory |
| | | color | opacity, |
| | | intensity | and uneven |
| | | | color |
| Alkali | Good | Fair | No good |
| Resistance | | | |
| Retriev- | Entire quantity | Limited | Unretrievable |
| ability | retrievable | retrievability | due to |
| | | due to pigment | violent |
| | | separation | pigment |
| | | | separation |

As shown in TABLE 1, Practical Example 1 yielded better results than Comparative Examples 1 and 2 in all items of evaluation. What was particularly notable with the powder coating composition of Practical Example 1 was that neither the base powder or the pigment flocculated, and that the pigment evenly coated the surface of the base powder. Moreover, the coating exhibited good adhesion to the test pieces, and exhibited satisfactory surface strength. On the other hand, Comparative Examples 1 and 2 suffered from flocculation of the pigment itself, and exhibited poor coating workability by causing pigment separation and producing spit. In particular, Comparative Example 2 yielded unsatisfactorily opacity and uneven color in the appearance of the finish, and proved unretrievable due to violent pigment separation.

### PRACTICAL EXAMPLE

Used as the materials for slurry were: 50 g of an aluminum foil powder with a mean particle size of 20 μm; and 60 g of a binder liquid (“Superflex” manufactured by Dai-ichi Kogyo Seiyaku Co., Ltd.) having a urethane elastomer dispersed in water. These were, along with 440 g of water, put in a beaker with a capacity of 1 L, and were agitated with a stirrer to produce slurry. The operation duration was two hours.

On the other hand, used as a resin powder as a base powder was 1 000 g of a white polyester powder (manufactured by Kuboko Paint Co., Ltd.). This was fed into a fluidized bed coater (“Agglomaster AGM-2SD” manufactured by Hosokawamicron Corporation) so as to be fluidized with a current of hot air at 60° C. As the temperature of the resin powder rose, a spray of the slurry prepared as described above was supplied into the bed of the fluidized powder by the use of a fluid-type bottom spray nozzle provided in the fluidized bed coater. The slurry was supplied at the rate of 15 g/min. As time passed, the resin powder became colored until, at the time that the entire quantity of the slurry prepared as described above was supplied in the form of a spray, a powder coating composition was produced that has the surface of the resin powder intensely colored in a metallic color. At this point, the supply of the spray was stopped. Consecutively, drying was performed with a current of hot air so that the moisture on the surface of the powder coating composition was evaporated, then cooling was performed, and then the powder coating composition was collected.

Next, with the collected powder coating composition, coating was performed (test pieces of a mild steel sheet were coated therewith, and were then baked at 180° C. for 20 minutes) by the use of an electrostatic spray gun (manufactured by Hosokawa Wagner Corporation). Then, the appearance of the finish was inspected by sight.

### COMPARATIVE EXAMPLE 3

Used as a resin powder as a base powder was 1 000 g of a white polyester powder (manufactured by Kuboko Paint Co., Ltd.), and used as a metal foil powder was 50 g of an aluminum foil powder with a mean particle size of 20 μm. These were fed into a fluidized bed coater (“Agglomaster AGM-2SD” manufactured by Hosokawamicron Corporation) so as to be fluidized with a current of hot air at 60° C. On the other hand, also used was 60 g of a binder liquid (“Superflex” manufactured by Dai-ichi Kogyo Seiyaku Co., Ltd.) having only a urethane elastomer dispersed in water. As the temperature of the resin powder rose, a spray of the binder liquid prepared as described above was supplied into the bed of the fluidized powder by the use of a fluid-type bottom spray nozzle provided in the fluidized bed coater, and thereby a powder coating composition was produced. Then, with the collected powder coating composition, coating was performed in the same way as described above in connection with Practical Example 2, and the appearance of the finish was inspected by sight.

The powder coating compositions of the practical and comparative examples presented above were compared in terms of the same evaluation items as with Practical Example 1 presented previously. The results are shown in Table 2.

TABLE 2

| Evaluation | Practical | Comparative |
|---|---|---|
| Item | Example 2 | Example 3 |
| Coating | No flocculation | No flocculation |
| Appearance | observed in either | observed in either |
| | base powder or | base powder or |
| | pigment alone | pigment alone |
| Coating | Neither pigment | Neither pigment |
| Workability | separation nor spit | separation nor spit |
| | observed | observed |
| Color/Gloss | Good | Slightly less gloss |
| Alkali | Good | Good |
| Resistance | | |
| Retrievability | Entire quantity | Entire quantity |
| | retrievable | retrievable |

As shown in TABLE 2, Practical Example 2 yielded a better result than Comparative Example 3 in color/gloss. This is because, as a result of a spray of slurry having an aluminum foil powder evenly dispersed therein being supplied to the surface of a resin powder as a base powder, the aluminum foil powder dispersed on the surface of the base powder, and promoted bonding in their evenly aligned state, with the result that, after application, the aluminum foil powder exhibited even alignment.

The embodiments described above deal with either a process for producing a colorant powder coating composition that uses slurry having a pigment in the form of fine powder or fine flakes dispersed therein or a process for producing a metallic powder coating composition that uses slurry having a metal foil powder dispersed therein. It should be understood, however, that the present invention can be applied to a process for producing any other type of powder coating composition, for example a so-called color-metallic powder coating composition that uses slurry having both a pigment in the form of fine powder or fine flakes and a metal foil powder mixedly dispersed therein.

### INDUSTRIAL APPLICABILITY

As described above, according to the present invention, a spray of slurry prepared by mixing together a pigment and a binder by dispersing the former in the latter is supplied to the surface of a resin powder fluidized in a fluidized bed. This makes it possible to disperse a highly flocculative pigment in the slurry, and also, by the action of the binder, to increase the adhesion between the resin powder and the pigment. Thus, it is possible to increase the dispersiveness of a fine-particle pigment so that it surely coats the surface of a base powder. Moreover, it is possible to produce a powder coating composition suitable for wide-variety small-quantity production.

1. A process for producing a powder coating composition, wherein a resin powder as a base powder is fluidized and a liquid in a form of slurry having a pigment dispersed therein is supplied in such a way that a spray of the pigment hits the fluidized resin powder so that the surface of the resin powder is coated with the pigment.

2. The process of claim 1, wherein the liquid in the form of slurry has a binder mixed therein.

3. The process of claim 2, wherein the pigment is a pigment in a form of fine powder or fine flakes, or a metal foil powder, or a mixture thereof.

4. The process of claim 3, wherein the resin powder has a mean particle size of 5 to 50 μm.

5. The process of claim 4, wherein the pigment in the form of fine powder or fine flakes has a mean particle size of 0.001 to 50 μm.

6. The process of claim 5, wherein the resin powder and the pigment in the form of fine powder or fine flakes are mixed together in a ratio of, on a weight percentage basis, 100 of the resin powder to 0.5 to 40 of the pigment.

7. The process of claim 4, wherein the metal foil powder has a mean particle size of 1 to 50 μm.

8. The process of claim 7, wherein the resin powder and the metal foil powder are mixed together in a ratio of, on a weight percentage basis, 100 of the resin powder to 0.5 to 15 of the metal foil powder.

9. A powder coating composition produced by the process of claim 1.
